(19) United States
(12) Patent Application Publication
(10) Pub. No.: US 2026/0066403 A1
(43) Pub. Date: Mar. 5, 2026

(54) SELF-ASSEMBLED CAST POLYPROPYLENE (CPP) BASE FILM OF ALUMINUM-PLASTIC FILM FOR NEW ENERGY POUCH BATTERIES AND PREPARATION METHOD THEREOF

(71) Applicants: Guizhou Institute of Metallurgy and Chemical Engineering, Guiyang (CN); Guizhou Nanomaterials Engineering Center, Guiyang (CN); Guizhou tianrunda technology co., ltd, Guiyang (CN)

(72) Inventors: Shu Zeng, Guiyang (CN); Xiaoxiao HUANG, Guiyang (CN); Kang Yang, Guiyang (CN); Yi Zhang, Guiyang (CN); Yulong MA, Guiyang (CN); Juheng WANG, Guiyang (CN); Anlan ZHONG, Guiyang (CN)

(21) Appl. No.: 19/249,705

(22) Filed: Jun. 25, 2025

(30) Foreign Application Priority Data
Sep. 4, 2024 (CN) 202411234844.2

(51) Int. Cl. H01M 50/124; B29C 48/154; B29C 48/21; B29C 71/04; B29K 23/00; B29K 705/02; B29L 31/34; H01M 50/105; H01M 50/119; H01M 50/121

(52) U.S. Cl. CPC H01M 50/124; B29C 71/04; H01M 50/105; H01M 50/119; H01M 50/121; B29C 48/154; B29C 48/21; B29K 2023/12; B29K 2705/02; B29L 2031/3468

(57) ABSTRACT

Disclosed is a self-assembled cast polypropylene (CPP) base film of an aluminum-plastic film for new energy pouch batteries and a preparation method thereof. The base film comprises a self-assembled heat sealing layer, a support layer and a composite layer. The preparation process includes charging the raw materials of three layers into a three-layer co-extrusion casting machine and setting the relevant parameters for preparation, then performing a corona treatment. The present disclosure utilizes an organic hybrid micro-nano thermal conductive material to induce the heat sealing layer to produce a self-assembly function in a high temperature environment after heat sealing, thereby effectively preventing the pouch batteries from short circuit or explosion in a high temperature environment.

### CROSS-REFERENCE TO RELATED APPLICATION

This application claims priority of Chinese Patent Application No. 202411234844.2, filed on Sep. 4, 2024, the entire contents of which are incorporated herein by reference.

### TECHNICAL FIELD

The present disclosure relates to the technical field of battery packaging materials, and more specifically to a self-assembled CPP base film of an aluminum-plastic film for new energy pouch batteries and a preparation method thereof.

### BACKGROUND

The aluminum-plastic film for lithium-ion battery soft packaging is a composite soft packaging material composed of a base material such as BOPA, an aluminum foil, a sealing layer such as cast polypropylene (CPP) and an adhesive. As a packaging material for lithium batteries, an aluminum-plastic film must have good heat sealing properties, insulation properties, mechanical strength and ductility, it must also have barrier properties against moisture and oxygen, etc., as well as very high chemical stability against corrosive acids, alkalis, and salts, etc. inside the battery. As the inner layer of an aluminum-plastic film, the fundamental core requirement for CPP is to play the role of sealing and insulation.

The damage of pouch batteries mainly occurs at the sealing part of the battery, and thus the heat sealing strength of the sealing position during long-term use or storage is a very critical parameter. Under normal temperature usage conditions, the sealing part of the battery is required to have a high heat sealing strength to ensure the long-term safety use of the battery. However, since in high temperature scenarios, the heat sealing strength of the sealing part of pouch batteries is too high, the electrolyte inside the battery is prone to producing a large amount of gas under high temperature and it cannot be discharged in time, which will cause a short circuit inside the battery or battery explosion due to high pressure, posing a serious safety hazard. Especially for power batteries, in high-rate and high-heat generation scenarios, the gas inside the battery needs to be discharged in time when the temperature is above 120° C. so as to prevent battery explosion and safety accidents.

At present, there has been no relevant technical breakthrough in the problem of timely discharge of high-temperature gas in pouch batteries, and there are few reports at home and abroad. Therefore, how to provide a new technology is an urgent problem to be solved by those skilled in the art.

### SUMMARY

In view of this, the present disclosure innovatively provides a self-assembled CPP base film of an aluminum-plastic film for new energy pouch batteries and a preparation method thereof, and utilizes organic micro-nano thermal conductive materials to induce the CPP heat sealing layer to produce a self-assembly function in order to better solve the above problems.

To achieve the above objective, the present disclosure uses the following technical solutions:

A self-assembled CPP base film of an aluminum-plastic film for new energy pouch batteries comprises a self-assembled heat sealing layer, a support layer and a composite layer arranged in sequence; a thickness of the CPP base film is 20 μm to 90 μm, and a thickness ratio of the self-assembled heat sealing layer, the support layer and the composite layer is (1-3): (4-8): (1-3).

Preferably, the self-assembled heat sealing layer comprises, by weight percentage, 69% to 96% of ternary random copolymer polypropylene, 0% to 20% of binary random copolymer polypropylene, 3% to 6% of opening slipping agent and 1% to 5% of organic hybrid micro-nano thermal conductive material.

Further, the opening slipping agent is one or more of organic silicones, siloxane polymers, and high molecular weight silicone waxes; the organic hybrid micro-nano thermal conductive material is the one prepared by a sol-gel method using one or more of silicon dioxide, calcium carbonate, calcium silicate, and barium sulfate, etc. and organic surface modifiers.

Further, the preparation method of the organic hybrid micro-nano thermal conductive material comprises:
mixing the organic surface modifier and the inorganic nanomaterial in a mass ratio of 1:99 to 5:95, and then preparing the organic hybrid micro-nano thermal conductive material by a sol-gel method, with a temperature controlled at −10 to 120° C., a pressure of 1.0 MPa to 3.0 MPa, and a reaction time of 1 h to 10 h.

The organic surface modifier is one or more of a silane coupling agent, a titanate coupling agent, an aluminate coupling agent, and a borate coupling agent.

Preferably, the support layer comprises, by weight percentage, 50% to 90% of block copolymer polypropylene, 0% to 10% of binary random copolymer polypropylene, 0% to 10% of ternary random copolymer polypropylene, 5% to 10% of polyolefin elastomer, and 5% to 20% of acidified polypropylene.

Further, the polyolefin elastomer is one or more of a polypropylene elastomer, a polyethylene elastomer, an ethylene-propylene rubber, and an ultra-low density polyethylene; and the selected block polypropylene has a melting point of ≥163° C. and a melt index of 2-10 g/10 min, preferably a melt index of 3-8 g/10 min.

Further, the ternary random copolymer polypropylene has a melting point of 125° C. to 135° C., a melt index of 3 to 12 g/10 min (230° C., 2.16 kg), and preferably a melt index of 5-9 g/10 min.

Preferably, the composite layer comprises, by weight percentage, 50% to 89% of binary random copolymer polypropylene, 5% to 15% of block copolymer polypropylene, 5% to 30% of acidified polypropylene, and 1% to 5% of vinyl acetate.

Further, the acidified polypropylene is maleic anhydride grafted modified polypropylene, with a grafting rate of ≥2% and a melt index of 3-12 g/10 min.

Further, the binary random copolymer polypropylene has a melting point of ≥140° C. and a melt index of 3-12 g/10 min, preferably a melt index of 5-9 g/10 min.

Preferably, the acetic acid content of the vinyl acetate is 20 wt % to 30 wt %, and the melt index is 10 to 30 g/10 min.

In addition, the present disclosure also provides a preparation method for a self-assembled CPP base film of an aluminum-plastic film for new energy pouch batteries as described in the above technical solution, which comprises the following steps:
(1) weighing the raw materials of the self-assembled heat sealing layer, the support layer and the composite layer by weight percentage;
(2) correspondingly charging the raw materials of the heat sealing layer, the support layer and the composite layer separately into the extruders A, B and C corresponding to the three-layer co-extrusion casting machine, starting the machine after debugging the equipment according to the thickness ratio of the layers and the processing temperature of the extruder, preparing the thin film by the co-extrusion casting process, and then carrying out a corona treatment with a corona machine at an output power of 2-70 KW and an output frequency of 10-25 KHZ to obtain the self-assembled CPP base film of an aluminum-plastic film for new energy pouch batteries.

Preferably, in step (2), the extrusion temperature of extruders A and C is 230° C., and the extrusion temperature of extruder B is 255° C.

It can be seen from the above technical solution that, compared with the existing technology, the present disclosure discloses a self-assembled CPP base film of an aluminum-plastic film for new energy pouch batteries and a preparation method thereof, which has the following beneficial effects:

The self-assembled CPP base film of an aluminum-plastic film prepared by the present disclosure is prepared by a three-layer co-extrusion process, and consists of a first self-assembled heat sealing layer (inner layer), a second support layer (core layer) and a third composite layer (surface layer); the self-assembled CPP film prepared by adjusting the proportion of each layer shows good heat sealing strength after heat sealing cooling, and has good bonding strength between functional layers; under high temperatures (>120° C.), polypropylene undergoes phase transformation into a viscous flow state at the heat sealing bonding site under the induction of an organic hybrid micro-nano thermal conductive material, and as the heat sealing strength decreases, more micropores will automatically present; as the temperature decreases, the heat sealing strength increases, and the micropores will automatically close, showing good self-assembling function, while taking into account good electrolyte resistance performance and not causing stress whitening; when it is used in pouch batteries of new energy vehicles, the gas generated by the increased electrolyte temperature inside the battery can be automatically discharged under high temperature conditions, preventing bulging and explosion caused by the increased internal pressure of the battery, thereby effectively preventing the safety hazards of pouch batteries of new energy vehicles. The production method provided by the present disclosure is carried out through a three-layer co-extrusion casting process, has simple manufacturing, low cost, abundant raw material sources and is environmentally friendly.

### BRIEF DESCRIPTION OF DRAWINGS

In order to more clearly illustrate the embodiments of the present disclosure or the technical solutions in the existing technology, the drawings required for use in the embodiments or the description of the existing technology will be briefly introduced below. Obviously, the drawings described below are only embodiments of the present disclosure, and for ordinary technicians in the art, other drawings can be obtained based on the provided drawings without paying creative work.

FIG. 1 is a schematic flow chart of a preparation method for a self-assembled CPP base film of an aluminum-plastic film according to the present disclosure.

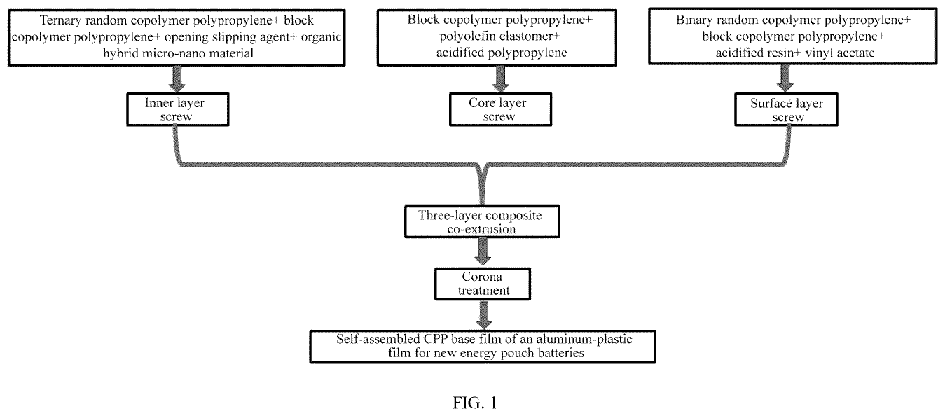

### DETAILED DESCRIPTION OF EMBODIMENTS

The technical solutions of the present disclosure will be described clearly and completely in conjunction with the embodiments of the present disclosure below. Obviously, the described embodiments are part of the embodiments of the present disclosure, rather than all of them. Based on the embodiments in the present disclosure, all other embodiments obtained by those ordinarily skilled in the art without creative work belong to the scope of protection of the present disclosure.

### Example 1

In terms of weight percentage, the self-assembled heat sealing layer was prepared by using 90% of ternary random copolymer polypropylene, 5% of binary random copolymer polypropylene, 3% of opening slipping agent and 2% of organic hybrid micro-nano thermal conductive material, wherein the ternary random copolymer polypropylene had a melting point of 131° C. and a melt index of 7.6 g/10 min; the binary random copolymer polypropylene (Shanghai Petrochemical Company 800E) had a melting point of 143° C., and a melt index of 7.5 g/10 min; the organic hybrid micro-nano thermal conductive material was a self-made monodispersed organic hybrid silica thermal conductive material, and the specific preparation method was as follows:
silane coupling agent and nano-silicon dioxide were mixed in a mass ratio of 3:97, and the sol-gel method was used with a temperature controlled at 850° C., a pressure of 2.0 MPa, and a reaction time of 7 h.

The support layer was prepared by using 70% of block copolymer polypropylene, 5% of binary random copolymer polypropylene (Shanghai Petrochemical Company 800E), 5% of ternary random copolymer polypropylene (Maoming Petrochemical Company F4908), 8% of polyolefin elastomer and 12% of acidified polypropylene, wherein the block copolymer polypropylene (Maoming Petrochemical Company HR2106M) had a melting point of 165° C. and a melt index of 5.2 g/10 min; polyolefin elastomer (Vistamaxx 6202); and acidified polypropylene resin (Guangzhou Lushan AP302N).

The composite layer was prepared by using 80% of binary random copolymer polypropylene (Shanghai Petrochemical Company 800E), 5% of block copolymer polypropylene (Maoming Petrochemical Company HR2106M), 12% of acidified polypropylene (Guangzhou Lushan AP302N) and 3% of vinyl acetate (Zhongkelai Refinery&Petrochemical Company UE2825).

The above-mentioned raw materials of heat sealing layer, support layer and composite layer were mixed in terms of weight percentage, and charged into the corresponding extruders of the three-layer co-extrusion casting machine (the layer structure was ABC), and the thickness ratio of the three layers was set to 1:8:1, the temperature of extruder B was set to 255° C., and the temperature of extruders A and C was set to 230° C.; a self-assembled CPP film of 80 μm was made by co-extrusion casting process, and the corona treatment was carried out with a corona machine at an output power of 2-70 KW and an output frequency of 10-25 kHz, and the surface tension of the composite layer lowering machine was ≥42 dyn.

### Example 2

In terms of weight percentage, the self-assembled heat sealing layer was prepared by using 85% of ternary random copolymer polypropylene, 8% of binary random copolymer polypropylene, 4% of opening slipping agent and 3% of organic hybrid micro-nano thermal conductive material, wherein the ternary random copolymer polypropylene had a melting point of 131° C. and a melt index of 7.6 g/10 min; the binary random copolymer polypropylene (Shanghai Petrochemical Company 800E) had a melting point of 143° C., and a melt index of 7.5 g/10 min; the organic hybrid micro-nano thermal conductive material was a self-made monodispersed organic hybrid silica thermal conductive material, and the specific preparation method was as follows:
silane coupling agent and nano-silicon dioxide were mixed in a mass ratio of 3:97, and the sol-gel method was used with a temperature controlled at 850° C., a pressure of 2.0 MPa, and a reaction time of 7 h.

The support layer was prepared by using 72% of block copolymer polypropylene, 7% of binary random copolymer polypropylene (Shanghai Petrochemical Company 800E), 3% of ternary random copolymer polypropylene (Maoming Petrochemical Company F4908), 8% of polyolefin elastomer and 10% of acidified polypropylene, wherein the block copolymer polypropylene (Maoming Petrochemical Company HR2106M) had a melting point of 165° C. and a melt index of 5.2 g/10 min; polyolefin elastomer (Vistamaxx 6202); and acidified polypropylene resin (Guangzhou Lushan AP302N).

The composite layer was prepared by using 75% of binary random copolymer polypropylene (Shanghai Petrochemical Company 800E), 7% of block copolymer polypropylene (Maoming Petrochemical Company HR2106M), 15% of acidified polypropylene (Guangzhou Lushan AP302N) and 3% of vinyl acetate (Zhongkelai Refinery&Petrochemical Company UE2825).

The above-mentioned raw materials of heat sealing layer, support layer and composite layer were mixed, respectively in terms of weight percentage, and charged into the corresponding extruders of the three-layer co-extrusion casting machine (the layer structure was ABC), and the thickness ratio of the three layers was set to 2:6:2, the temperature of extruder B was set to 255° C., and the temperature of extruders A and C was set to 230° C.; a self-assembled CPP film of 80 μm was made by co-extrusion casting process, and the corona treatment was carried out with a corona machine at an output power of 2-70 KW and an output frequency of 10-25 kHz, and the surface tension of the composite layer lowering machine was ≥42 dyn.

### Example 3

In terms of weight percentage, the self-assembled heat sealing layer was prepared by using 94% of ternary random copolymer polypropylene, 5% of opening slipping agent and 1% of organic hybrid micro-nano thermal conductive material, wherein the ternary random copolymer polypropylene had a melting point of 131° C. and a melt index of 7.6 g/10 min; the binary random copolymer polypropylene (Shanghai Petrochemical Company 800E) had a melting point of 143° C., and a melt index of 7.5 g/10 min; the organic hybrid micro-nano thermal conductive material was a self-made monodispersed organic hybrid silica thermal conductive material, and the specific preparation method was as follows:
silane coupling agent and nano-silicon dioxide were mixed in a mass ratio of 3:97, and the sol-gel method was used with a temperature controlled at 850° C., a pressure of 2.0 MPa, and a reaction time of 7 h.

The support layer was prepared by using 75% of block copolymer polypropylene, 5% of ternary random copolymer polypropylene (Maoming Petrochemical Company F4908), 10% of polyolefin elastomer and 10% of acidified polypropylene, wherein the block copolymer polypropylene (Maoming Petrochemical Company HR2106M) had a melting point of 165° C. and a melt index of 5.2 g/10 min; polyolefin elastomer (Vistamaxx 6202); and acidified polypropylene resin (Guangzhou Lushan AP302N).

The composite layer was prepared by using 65% of binary random copolymer polypropylene (Shanghai Petrochemical Company 800E), 10% of block copolymer polypropylene (Maoming Petrochemical Company HR2106M), 20% of acidified polypropylene (Guangzhou Lushan AP302N) and 5% of vinyl acetate (Zhongkelai Refinery&Petrochemical Company UE2825).

The above-mentioned raw materials of heat sealing layer, support layer and composite layer were mixed, respectively in terms of weight percentage, and charged into the corresponding extruders of the three-layer co-extrusion casting machine (the layer structure was ABC), and the thickness ratio of the three layers was set to 2:6:2, the temperature of extruder B was set to 255° C., and the temperature of extruders A and C was set to 230° C.; a self-assembled CPP film of 80 μm was made by co-extrusion casting process, and the corona treatment was carried out with a corona machine at an output power of 2-70 KW and an output frequency of 10-25 kHz, and the surface tension of the composite layer lowering machine was ≥42 dyn.

### Comparative Example 1

This Comparative example adopted aluminum-plastic film H152-EL from Xinlun New Materials Co., Ltd.

### Comparative Example 2

This Comparative example adopted aluminum-plastic film CAP153 from MatCrown New Materials Co., Ltd.

### Comparative Example 3

This Comparative example adopted aluminum-plastic film DM-L152N from Daoming Optics Co., Ltd.

### Performance Testing

The CPP films in the above Examples 1 to 3 and Comparative Examples 1 to 3 were made into aluminum-plastic films (with an aluminum foil layer thickness of 40 um, a nylon layer thickness of 25 um), and after the aluminum-plastic films were heat-sealed, the low-temperature heat sealing strength tests and high-temperature heat sealing strength tests, thermal peel strength evaluations, and deep-drawing performance tests were performed.

The test methods are as follows:
1. Heat sealing strength test: the aluminum-plastic film was heat sealed according to Standard TCIAPS0005-2018, and the test environment temperature was set to two groups: room temperature (23° C.) and high temperature (130° C.);
2. Thermal peel strength test: the composite aluminum-plastic film samples were immersed in electrolyte at 120° C. for 24 hours (in a sealed container), and the composite peel strength of CPP and aluminum foil layer was quickly tested by tensile testing machine after the samples were taken out;
3. Deep-drawing performance test: the deep-drawing performance of aluminum-plastic film was tested with a deep-drawing tester to evaluate the deep-drawing resistance of CPP thin film, with a deep-drawing depth of 8 mm; then stress whitening and cracking were observed, and five groups of samples were tested each time.

The test results are shown in the table below:

| | 23° C. | 130° C. | | Deep drawing |
|---|---|---|---|---|
| | Heat | Heat | | performance |
| | sealing | sealing | Thermal peel | (whitening |
| Test Items | strength | strength | strength/(N/15 mm) | condition) |
| Example 1 | 80 | 4.1 | 10.2 | None |
| Example 2 | 82 | 3.8 | 11.3 | None |
| Example 3 | 85 | 4.6 | 11.5 | None |
| Comparative | 80 | 52 | 8.3 | None |
| Example 1 | | | | |
| Comparative | 79 | 48 | 7.5 | None |
| Example 2 | | | | |
| Comparative | 81 | 54 | 7.8 | None |
| Example 3 | | | | |

The examples in the description are described in a progressive manner, and each example highlights the differences from the others, and the same or similar parts among examples can be referenced to each other.

The above descriptions of the disclosed examples enable those skilled in the art to implement or use the present disclosure. Various modifications to these examples will be apparent to those professionals skilled in the art, and the general principles as defined herein can be implemented in other examples without departing from the spirit or scope of the present disclosure. Therefore, the present disclosure will not be limited to the examples as shown herein, but will conform to the widest scope that is consistent with the principles and novel features disclosed herein.

1. A self-assembled cast polypropylene (CPP) base film of an aluminum-plastic film for new energy pouch batteries, comprising a self-assembled heat sealing layer, a support layer and a composite layer arranged in sequence; wherein a thickness of the CPP base film is 20 μm to 90 μm, and a thickness ratio of the self-assembled heat sealing layer, the support layer and the composite layer is (1-3): (4-8): (1-3);
wherein the self-assembled heat sealing layer comprises, by weight percentage, 69% to 96% of ternary random copolymer polypropylene, 0% to 20% of binary random copolymer polypropylene, 3% to 6% of opening slipping agent and 1% to 5% of organic hybrid micro-nano thermal conductive material;
wherein the organic hybrid micro-nano thermal conductive material is prepared by a sol-gel method using one or more of silicon dioxide, calcium carbonate, calcium silicate, and barium sulfate and an organic surface modifier, and a method for preparing the organic hybrid micro-nano thermal conductive material comprises:
mixing the organic surface modifier with an inorganic nanomaterial at a mass ratio of 1:99 to 5:95, and then preparing by a sol-gel method, wherein a temperature is controlled at −10° C. to 120° C., a pressure is 1.0 MPa to 3.0 MPa, and a reaction time is 1 h to 10 h; and the organic surface modifier is one or more of silane coupling agent, titanate coupling agent, aluminate coupling agent, and borate coupling agent;
wherein the support layer comprises, by weight percentage, 50% to 90% of block copolymer polypropylene, 0% to 10% of binary random copolymer polypropylene, 0% to 10% of ternary random copolymer polypropylene, 5% to 10% of polyolefin elastomer, and 5% to 20% of acidified polypropylene;
wherein the composite layer comprises, by weight percentage, 50% to 89% of binary random copolymer polypropylene, 5% to 15% of block copolymer polypropylene, 5% to 30% of acidified polypropylene, and 1% to 5% of vinyl acetate; and
wherein the acidified polypropylene is maleic anhydride grafted modified polypropylene, with a grafting rate of ≥2%, and a melt index of 3-12 g/10 min.

2. The self-assembled CPP base film of an aluminum-plastic film for new energy pouch batteries according to claim 1, wherein the opening slipping agent is one or more of organic silicones, siloxane polymers, and high molecular weight silicone waxes.

3. The self-assembled CPP base film of an aluminum-plastic film for new energy pouch batteries according to claim 1, wherein the polyolefin elastomer is one or more of a polypropylene elastomer, a polyethylene elastomer, an ethylene-propylene rubber, and an ultra-low density polyethylene; and the selected block polypropylene has a melting point of ≥163° C. and a melt index of 2-10 g/10 min.

4. The self-assembled CPP base film of an aluminum-plastic film for new energy pouch batteries according to claim 1, wherein the melting point of the ternary random copolymer polypropylene is 125° C. to 135° C. and the melt index is 3 to 12 g/10 min.

5. The self-assembled CPP base film of an aluminum-plastic film for new energy pouch batteries according to claim 1, wherein the binary random copolymer polypropylene has a melting point of ≥140° C. and a melt index of 3-12 g/10 min.

6. The self-assembled CPP base film of an aluminum-plastic film for new energy pouch batteries according to claim 1, wherein the acetic acid content of the vinyl acetate is 20 wt % to 30 wt %, and the melt index is 10-30 g/10 min.

7. The method for preparing a self-assembled CPP base film of an aluminum-plastic film for new energy pouch batteries according to claim 1, comprising the following steps:
(1) weighing the raw materials of the self-assembled heat sealing layer, the support layer and the composite layer by weight percentage;
(2) correspondingly charging the raw materials of the self-assembled heat sealing layer, the support layer and the composite layer separately into the extruders A, B and C corresponding to the three-layer co-extrusion casting machine, starting the machine after debugging the equipment according to the thickness ratio of the layers and the processing temperature of the extruder, preparing the thin film by the co-extrusion casting process, and then carrying out a corona treatment with a corona machine at an output power of 2-70 KW and an output frequency of 10-25 kHz to obtain the self-assembled CPP base film of an aluminum-plastic film for new energy pouch batteries.

8. The method for preparing a self-assembled CPP base film of an aluminum-plastic film for new energy pouch batteries according to claim 2, comprising the following steps:
(1) weighing the raw materials of the self-assembled heat sealing layer, the support layer and the composite layer by weight percentage;
(2) correspondingly charging the raw materials of the self-assembled heat sealing layer, the support layer and the composite layer separately into the extruders A, B and C corresponding to the three-layer co-extrusion casting machine, starting the machine after debugging the equipment according to the thickness ratio of the layers and the processing temperature of the extruder, preparing the thin film by the co-extrusion casting process, and then carrying out a corona treatment with a corona machine at an output power of 2-70 KW and an output frequency of 10-25 kHz to obtain the self-assembled CPP base film of an aluminum-plastic film for new energy pouch batteries.

9. The method for preparing a self-assembled CPP base film of an aluminum-plastic film for new energy pouch batteries according to claim 3, comprising the following steps:
(1) weighing the raw materials of the self-assembled heat sealing layer, the support layer and the composite layer by weight percentage;
(2) correspondingly charging the raw materials of the self-assembled heat sealing layer, the support layer and the composite layer separately into the extruders A, B and C corresponding to the three-layer co-extrusion casting machine, starting the machine after debugging the equipment according to the thickness ratio of the layers and the processing temperature of the extruder, preparing the thin film by the co-extrusion casting process, and then carrying out a corona treatment with a corona machine at an output power of 2-70 KW and an output frequency of 10-25 kHz to obtain the self-assembled CPP base film of an aluminum-plastic film for new energy pouch batteries.

10. The method for preparing a self-assembled CPP base film of an aluminum-plastic film for new energy pouch batteries according to claim 4, comprising the following steps:
(1) weighing the raw materials of the self-assembled heat sealing layer, the support layer and the composite layer by weight percentage;
(2) correspondingly charging the raw materials of the self-assembled heat sealing layer, the support layer and the composite layer separately into the extruders A, B and C corresponding to the three-layer co-extrusion casting machine, starting the machine after debugging the equipment according to the thickness ratio of the layers and the processing temperature of the extruder, preparing the thin film by the co-extrusion casting process, and then carrying out a corona treatment with a corona machine at an output power of 2-70 KW and an output frequency of 10-25 kHz to obtain the self-assembled CPP base film of an aluminum-plastic film for new energy pouch batteries.

11. The method for preparing a self-assembled CPP base film of an aluminum-plastic film for new energy pouch batteries according to claim 5, comprising the following steps:
(1) weighing the raw materials of the self-assembled heat sealing layer, the support layer and the composite layer by weight percentage;
(2) correspondingly charging the raw materials of the self-assembled heat sealing layer, the support layer and the composite layer separately into the extruders A, B and C corresponding to the three-layer co-extrusion casting machine, starting the machine after debugging the equipment according to the thickness ratio of the layers and the processing temperature of the extruder, preparing the thin film by the co-extrusion casting process, and then carrying out a corona treatment with a corona machine at an output power of 2-70 KW and an output frequency of 10-25 kHz to obtain the self-assembled CPP base film of an aluminum-plastic film for new energy pouch batteries.

12. The method for preparing a self-assembled CPP base film of an aluminum-plastic film for new energy pouch batteries according to claim 6, comprising the following steps:
(1) weighing the raw materials of the self-assembled heat sealing layer, the support layer and the composite layer by weight percentage;
(2) correspondingly charging the raw materials of the self-assembled heat sealing layer, the support layer and the composite layer separately into the extruders A, B and C corresponding to the three-layer co-extrusion casting machine, starting the machine after debugging the equipment according to the thickness ratio of the layers and the processing temperature of the extruder, preparing the thin film by the co-extrusion casting process, and then carrying out a corona treatment with a corona machine at an output power of 2-70 KW and an output frequency of 10-25 kHz to obtain the self-assembled CPP base film of an aluminum-plastic film for new energy pouch batteries.

13. The method for preparing a self-assembled CPP base film of an aluminum-plastic film for new energy pouch batteries according to claim 7, wherein in the step (2), an extrusion temperature of extruders A and C is 230° C., and the extrusion temperature of extruder B is 255° C.

14. The method for preparing a self-assembled CPP base film of an aluminum-plastic film for new energy pouch batteries according to claim 8, wherein in the step (2), an extrusion temperature of extruders A and C is 230° C., and the extrusion temperature of extruder B is 255° C.

15. The method for preparing a self-assembled CPP base film of an aluminum-plastic film for new energy pouch batteries according to claim 9, wherein in the step (2), an extrusion temperature of extruders A and C is 230° C., and the extrusion temperature of extruder B is 255° C.

16. The method for preparing a self-assembled CPP base film of an aluminum-plastic film for new energy pouch batteries according to claim 10, wherein in the step (2), an extrusion temperature of extruders A and C is 230° C., and the extrusion temperature of extruder B is 255° C.

17. The method for preparing a self-assembled CPP base film of an aluminum-plastic film for new energy pouch batteries according to claim 11, wherein in the step (2), an extrusion temperature of extruders A and C is 230° C., and the extrusion temperature of extruder B is 255° C.

18. The method for preparing a self-assembled CPP base film of an aluminum-plastic film for new energy pouch batteries according to claim 12, wherein in the step (2), an extrusion temperature of extruders A and C is 230° C., and the extrusion temperature of extruder B is 255° C.
